(19) United States
(12) Patent Application Publication
(10) Pub. No.: US 2025/0123615 A1
(43) Pub. Date: Apr. 17, 2025

(54) METHOD, SYSTEM AND COMPUTER PROGRAM FOR PLANNING PRODUCTION IN A PRODUCTION PLANT CONSISTING OF A PLURALITY OF SEPARATE, SUCCESSIVE PLANT PARTS, IN PARTICULAR A METALLURGICAL PRODUCTION PLANT FOR PRODUCING INDUSTRIAL GOODS SUCH AS METAL SEMI-FINISHED PRODUCTS AND/OR METAL END PRODUCTS

(71) Applicant: SMS group GmbH, Düsseldorf (DE)

(72) Inventor: Carsten Andreas KLEIN, Düsseldorf (DE)

(73) Assignee: SMS group GmbH, Düsseldorf (DE)

(21) Appl. No.: 18/568,512

(22) PCT Filed: Jun. 1, 2022
(86) PCT No.: PCT/EP2022/064977

§ 371 Date: Jan. 15, 2024

(30) Foreign Application Priority Data
Jun. 10, 2021 (DE) 10 2021 205 910.4

(51) Int. Cl. G05B 19/418

(52) U.S. Cl. CPC G05B 19/41865; G05B 2219/32088

(57) ABSTRACT

A method for planning production in a production plant having a plurality of separate, successive plant parts is disclosed. The products to be manufactured in the production plant are available in a production list and/or production sub-lists are available for the separate, successive plant parts or are established from the production list. The method includes analyzing the production sub-lists and determining production sequences for the relevant plant parts. Those products that can be manufactured in the relevant plant part and can be manufactured without restricting or interrupting production in the plant part are combined in each production sequence. The method further includes analyzing the production sequences of the plant parts and determining at least one overall production sequence for the production plant. Products that are included for all the plant parts in a joint production sequence are included in an overall production sequence.

### CROSS-REFERENCE TO RELATED APPLICATION

This application is a national stage application, filed under 35 U.S.C. § 371, of International Patent Application PCT/EP2022/064977, filed on Jun. 1, 2022, which claims the benefit of German Patent Application DE 10 2021 205 910.4, filed on Jun. 10, 2021.

### TECHNICAL FIELD

The disclosure relates to a method for planning production in a production plant consisting of a plurality of separate, successive plant parts, in particular a metallurgical production plant for producing industrial goods such as metal semi-finished products and/or metal end products. The disclosure also relates to a system and a computer program for planning production in a production plant consisting of a plurality of separate, successive plant parts, in particular a metallurgical production plant for producing industrial goods such as metal semi-finished products and/or metal end products.

### BACKGROUND

In production plants with a plurality of separate, successive plant parts, such as metallurgical production plants for producing industrial goods such as metal semi-finished products and/or metal end products, various process steps are linked together. Different process steps for the manufacture of an end product of the production plant are carried out in the separate plant parts. The (intermediate) product manufactured in a plant part serves as an input product for the subsequent plant part or is delivered to a customer as an intermediate product or, after processing in the last plant part, as a final product. Thereby, the plant parts can be spatially separated from one another and the (intermediate) products can be transported between the plant parts, stored temporarily or the like.

The products to be manufactured in the production plant/in the separate plant parts are available in a production list/in production sub-lists for the separate plant parts. The production sub-lists can be derived from the production list, for example.

Products from the production sub-lists are manufactured in production sequences in the separate plant parts, preferably one immediately after the other. Thereby, different products usually require an adjustment to the operation of the plant part, an adjustment to the mechanical equipment of the plant, the performance of maintenance work on the plant part or comparable modifications to the plant part. Therefore, a product changeover in a production sequence can cause a delay and unnecessary rejects. Delays arise, for example, by set-up times or the replacement of wearing parts. Rejects can occur due to transient production conditions, wherein the product manufactured during the transition period does not fulfill the requirements of the end product. Furthermore, wearing parts can be replaced at a non-optimized, in particular too early, point in time.

According to the prior art, production in a plant part can be optimized manually and/or with system support. Thereby, the optimization relates in particular to the determination of the production sequence, i.e. the specification of the production order in a plant part. For example, comparable products are grouped together in a production sequence with system support. It is known to use algorithms that perform similarity checks between products and filter the order volume.

The products to be manufactured in the production plant require a plurality of production steps, which are carried out in the separate plant parts. The separate plant parts relate to different plant types, each of which has different (product) features that are relevant for the evaluation of product transitions within the production sequence. The chemical composition of the products to be manufactured can be relevant with respect to one plant part, while the product dimensions of the products to be manufactured can be relevant for another plant part. Due to the complex dependencies and the large number of individual production orders, manual planning and optimization of production orders is not feasible, since the relationships between all production orders for all plant parts would have to be analyzed and optimized, taking into account set-up times, output losses or similar disadvantages. A system-supported global minimization of production orders, taking into account the product transitions of the production sequences across all plant parts, has also not yet taken place, as a result of which avoidable output losses and downtimes, which represent economic and social damage, arise.

### SUMMARY

One object of the disclosure is to plan production in a production plant consisting of a plurality of separate, successive plant parts and to optimize the production process across all plant parts for a predetermined production list. Thereby, downtimes and output losses in particular are to be minimized.

The object is achieved by a method for planning production in a production plant consisting of a plurality of separate, successive plant parts, in particular a metallurgical production plant for producing industrial goods such as metal semi-finished products and/or metal end products,
wherein the products to be manufactured in the production plant are available in a production list and/or production sub-lists are available for the separate, successive plant parts or are established from the production list, (e.g.: production list/production sub-lists optionally also including orders expected in the future)
comprising the steps of:

Analyzing the production sub-lists and determining production sequences for the relevant plant parts, wherein each production sequence combines the products that can be manufactured in the relevant plant part without restricting or interrupting production in the plant part,

Analyzing the production sequences of the plant parts and determining at least one overall production sequence for the production plant, wherein products that are included for all the plant parts in a joint production sequence are included in an overall production sequence.

The disclosure relates to a method for planning production in a production plant consisting of a plurality of separate, successive plant parts. In particular, these are industrial production plants such as, for example, a metallurgical production plant for producing industrial goods such as metal semi-finished products and/or metal end products.

Thereby, the products to be manufactured in the production plant are available in a production list. Alternatively, production sub-lists can be available for the separate plant parts or they can be derived from the production list of the production plant.

The production list/the production sub-lists can also comprise products expected in the future from expected incoming orders if the production plant can provide a corresponding forecast of incoming orders/receives them from another system.

In accordance with the method, the production sub-lists of the plant parts are analyzed in order to determine which products from the relevant production sub-list can be manufactured in the relevant plant part without restricting or interrupting production. On the basis of such analysis, production sequences are determined for the plant part, wherein each production sequence combines the products that can be manufactured in the relevant plant part without restricting or interrupting production in the plant part. Thus, the products included in a production sub-list are grouped together, wherein each group can be manufactured in the relevant plant part without restrictions/interruption. When switching between the groups, i.e. the production sequences, a production restriction or a production interruption is inevitably necessary.

A production restriction within the meaning of the disclosure involves a significant reduction in the output of the production plant or significant loss of resources in connection with a product changeover in the production process of the plant part.

In the following, the method analyzes which products from the production list/the production sub-lists are in each case included in a joint production sequence for all parts of the production plant. Thus, it is defined which products to be manufactured can be manufactured without interruption on all plant parts in the respective plant parts. On the basis of such analysis, at least one overall production sequence is determined for the production plant; each overall production sequence includes products that are included in a joint production sequence for all plant parts. Thus, an overall production sequence includes a possibility for manufacturing the products specified in the overall production sequence, which is without interruption in the individual plant parts.

As a result, production in a production plant consisting of a plurality of separate, successive plant parts is optimized. In particular, downtimes and output losses are minimized, for example by avoiding set-up times and output losses during transitions between products to be manufactured.

An increase in efficiency is achieved due to higher utilization of production capacities, for example by minimizing plant downtimes. Output losses are avoided through optimized product changeovers. This results in a more economical operation of the production plant, as well as avoiding the unnecessary use of resources in the company.

In accordance with a variant, a product is assigned to a production sequence of a plant part if the product can be manufactured upstream or downstream of a product included in the production sequence without restricting or interrupting production. Therefore, for each plant part and each combination of two products from the production sub-list of the relevant plant part, there is a check of whether these can be manufactured consecutively without interruption.

In an advantageous variant, the method comprises the step of defining limit values for product properties in the separate plant parts that cause a production restriction or a production interruption. For each plant part, the product properties of the products to be manufactured that are substantial for production and that could cause a restriction/interruption of production in the plant part are identified. Limit values are defined for such product properties, upon the exceeding of which a production restriction or a production interruption is assumed. The defined limit values allow the products included in a production sub-list to be easily divided into production sequences, wherein each production sequence can be carried out without interruption in the relevant plant part. The limit values can be formed from a combination of individual parameters. In particular, the limit values are criteria for classifying product changeovers that can be evaluated by machine.

According to a particularly preferred variant, analyzing the production sub-lists to determine production sequences for the relevant plant parts comprises creating graph models for the plant parts. In a created graph model, the products included in the production sub-lists represent a node in the graph model and the nodes are connected to one another via an edge if the relevant products can be manufactured in the plant part without restricting or interrupting production. All nodes connected via edges in the graph model created thus form a production sequence for the relevant plant part. The production sub-lists are thus analyzed with the aid of computers and converted into a graph model. The production sequences can be derived from such graph model that have been created. As a result, even very extensive production sub-lists can be analyzed quickly and easily and converted into production sequences.

In principle, the method can be based on methods that can represent and evaluate relationships between the products included in the production sub-lists and their production in the plant parts. The production sequences can be derived easily and efficiently from the relationships, in particular the graph model

In accordance with an advantageous variant, analyzing the production sequences of the plant parts to determine at least one overall production sequence for the production plant comprises evaluating the graph models for the plant parts. Products are included in an overall production sequence if such products are connected via an edge for all plant parts in the corresponding graph models. Thus, the overall production sequence includes products that are included in a joint production sequence on all plant parts, i.e. that can be manufactured on all plant parts without interruption. Since the products in the graph models are represented by nodes and the interruption-free production sequences are defined by the edges, the graph models of the plant parts must be evaluated to determine which nodes in all graph models are connected via an edge.

In an alternative variant to the creation of graph models, analyzing the production sub-lists to determine production sequences for the relevant plant parts comprises creating lists, in particular lists of vectors, adjacency matrices, or comparable data structures for recording relationship networks. The lists, adjacency matrices or comparable data structures created can then be evaluated in the same way as the graph models created, in order to determine an overall production sequence for the production plant.

According to an expedient variant, only those parts of an overall production sequence that require production in the same successive plant parts are taken into account. Thus, the products included in an overall production sequence require the same sequence of production steps during manufacture. In contrast, it is possible that the production sequences of the plant parts include products that do not require processing in all plant parts. For example, the production sequences of the plant parts include products that are delivered to a customer after processing by a plant part or processing by a portion of the available plant parts.

In accordance with a variant, the production sequences of the plant parts at least partially include products that are part of different overall production sequences. It is therefore possible that products of a production sequence in one plant part are part of a plurality of production sequences of another plant part, such that a plurality of overall production sequences arises. For example, products can be included in one production sequence in an upstream plant part, while the same products are included in two different production sequences in a downstream plant part. Since an overall production sequence only includes products that are included on all the plant parts in a production sequence, two overall production sequences are determined in this example, due to different production sequences in the subsequent plant part. For example, the production sequence of the upstream plant part includes products that are included in two overall production sequences. This is only an exemplary explanation and the reverse is also possible, i.e. that a production sequence of a downstream plant part includes products from two production sequences of an upstream plant part.

In a particularly preferred variant, the method comprises the step of optimizing a plurality of overall production sequences to determine a master production sequence. The master production sequence preferably comprises all products to be manufactured in the production plant from the production list and/or the production sub-lists. If not all of the products to be manufactured in the production plant, which are predetermined by the production list/production sub-lists, can be manufactured in an overall production sequence, the carrying out of the plurality of specific overall production sequences is optimized in accordance with this variant. In particular, it is taken into account that production sequences can be part of different overall production sequences. When determining the master production sequence, the production sequences and their link to the overall production sequences are therefore taken into account in particular. In particular, the master production sequence only provides for production restrictions or production interruptions in plant parts where these are unavoidable due to the linking of the overall production sequences. The master production sequence thus preferably reduces production restrictions or production interruptions to a minimum.

According to an expedient variant, the number, weight, volume or similar properties of products that are manufactured at an early stage in a production sequence, but are only taken into account at a later point in time in subsequent overall production sequences, are further taken into account when determining the master production sequence. Early manufacture as part of a production sequence and subsequent consideration in an overall production sequence should be as short as possible.

In a variant, the method comprises the step of determining production start times and production end times for the products to be manufactured listed in the production list or in the production sub-lists. Thus, for the individual products to be manufactured, when production begins and when it is completed is established. If required, the corresponding start and end times of processing can also be determined by the individual plant parts. This makes it possible to establish the processing status of the individual products to be manufactured and any intermediate products at any time.

In accordance with one variant, when determining the master production sequence, storage capacities of the production plant, the plant parts, intermediate storage facilities or the like are also taken into account, in particular for products that are manufactured at an early stage in a production sequence, but are only taken into account at a later point in time in subsequent overall production sequences.

In an advantageous variant, the optimization of a plurality of overall production sequences to determine the master production sequence is based on an algorithm for solving the job shop problem, in particular on an algorithm from the field of mixed-integer optimization, genetic optimization, heuristic methods from operation research such as particle swarm, simulated annealing, tabu search, predator-prey, or comparable algorithms.

According to an expedient variant, the master production sequence is determined forwards or backwards along a corresponding process chain. A production chain concerns, for example, the manufacture of products from the processing of raw materials through a plurality of processing steps into the desired product. The master sequence can be determined in both directions, taking into account the process chain.

In accordance with an advantageous variant, a prioritization of the plant parts is taken into account when determining the at least one overall production sequence and/or the master production sequence. Prioritization is based, for example, on the added value, capacity utilization or other properties of the plant parts. The overall production sequence and/or the master production sequence is determined iteratively, starting with the highest-priority plant part, such that optimum capacity utilization is achieved for such plant part.

In a preferred variant, the method comprises the step of checking the production sequences for the relevant plant parts for an actual interruption-free carrying out in the relevant plant part. Upon the check, the operational conditions and processes of the relevant plant part, in particular necessary maintenance downtimes, the replacement of operating change parts or the like, are taken into account. Even if a production sequence can theoretically be carried out without interruption in one plant part, operational conditions and processes can lead to necessary interruptions in production. Such production interruptions are caused, for example, by maintenance downtimes, replacement of operating change parts or the like. To prevent this, there is a check of whether a production sequence can actually be carried out without interruption under the current conditions in the relevant plant part. Thereby, expected states and conditions can also be taken into account on the basis of a prediction.

According to an expedient variant, the method comprises the step of dividing production sequences if actual interruption-free carrying out in the relevant plant part is not possible. Preferably, the integration of the production sequence to be divided into an overall production sequence is taken into account upon division, such that division of the overall production sequence is preferably avoided. If this is not possible, the overall production sequence must also be divided and a specific master production sequence must be newly determined if necessary.

In accordance with an advantageous variant, the method comprises the step of optimizing the production sequences for the plant parts with regard to the processing by the relevant plant part. The optimization is preferably based on an algorithm for solving the traveling salesman problem, in particular on an algorithm from the field of mixed-integer optimization, genetic optimization, heuristic methods from operation research such as particle swarm, simulated annealing, tabu search, predator-prey, or comparable algorithms. In the simplest case, sorting can also be carried out in accordance with one or more product properties.

In a preferred variant, the method takes into account the starting materials and their states for the products to be manufactured when planning production in the production plant. In particular, stock levels, delivery times, delivery conditions, availability of raw materials, state of starting materials, processing status of (intermediate) products or the like can be taken into account. As a result, product planning can be optimized in terms of time, but also with regard to tied-up capital or other economic aspects.

According to a further advantageous variant, the method comprises the step of defining a time horizon for the carrying out of the method, in particular with regard to the manufacture of the products from the production list and/or the production sub-lists. By minimizing production restrictions or production interruptions, the method achieves a time-optimized manufacture of the products. However, delivery dates, raw material availability or similar time constraints must be taken into account during planning. Since conditions can change continuously, planning for a specific time horizon is sufficient such that planning is continuous and optimal for such time horizon.

In accordance with an expedient variant, the method comprises the step of adjusting production at a later point in time during production if production capacity is still available within the defined time horizon.

In an advantageous variant, the method comprises the step of inserting a new product to be manufactured into existing production sequences and/or an overall production sequence. As a result, the planning can also be adjusted to incoming orders at short notice, in particular urgent incoming orders.

According to an expedient variant, the due date of the new product to be manufactured, the product properties or the like are taken into account upon insertion. In particular, similarities to product properties of products already planned and included in an overall production sequence and/or master production sequence can be taken into account.

Expediently, a new product to be manufactured in an existing overall production sequence is included if this does not unnecessarily delay the overall production sequence, in particular if it causes a separation of the overall production sequence. An unnecessary delay within the meaning of the disclosure is a delay exceeding the normal manufacturing time for the product to be inserted.

According to a preferred variant, the method comprises linking two existing overall production sequences by the inserted new product to be manufactured. The newly inserted product allows two previously separate overall production sequences to be combined into a single overall production sequence. This is made possible, for example, by the fact that the newly inserted product can mediate between two separate production sequences of a plant part; i.e., they are combined into one production sequence.

In a further variant, the method is carried out iteratively, in particular on a fixed chronological basis or after certain events such as completion of an optimization run, changes in state, receipt of new orders, or the like.

According to an expedient variant, the method is used to manufacture steel, non-ferrous metals, slabs, ingots, bars, strips, sheets, tubes, beams, forgings or the like. Non-ferrous metals include, for example, aluminum, copper, nickel or the like.

In accordance with a variant, the method comprises one or more of the following process steps: Melting, casting, hot forming, cold forming, pickling, coating, or the like.

In a further expedient variant, the plant parts are selected from: Blast furnaces, sintering plants, converters, electric arc furnaces, induction furnaces, ladle furnaces, vacuum treatment plants, powder atomization plants, continuous casting machines, ingot or mold foundries, hot rolling mills, cold rolling mills, pickling plants, rewinding lines, blasting lines, galvanizing lines, tinning lines, painting lines, slitting lines, cut-to-length lines, finishing lines, forging presses, closed-die forging, reheating furnaces, heat treatment lines, bell annealing, or the like.

According to a particularly preferred variant, when determining product sequences, the method takes into account the fact that two products can only be manufactured in a predetermined order without restricting or interrupting production. Due to the production conditions and/or product properties, it may be the case that transitions between two products do not involve the same effort/adjustments in the relevant plant part in both directions, such that these two products can only be manufactured in a specific sequence in one plant part without interruption.

In accordance with a variant, analyzing the production sub-lists to determine production sequences for the relevant plant part comprises creating graph models for the plant part, wherein, in a graph model, the products included in the production sub-lists represent a node in the graph model and the nodes are connected to one another via a directed edge, if the relevant products can be manufactured in the relevant production order without restricting or interrupting production in the plant part. Thus, a directed graph model is created, which takes into account the order of products in a production sequence in order to ensure interruption-free manufacture.

In an advantageous variant, analyzing the production sequences of the plant parts to determine at least one overall production sequence for the production plant comprises evaluating the graph models for the plant parts, wherein products are included in an overall production sequence if such products are connected via directed edges for all plant parts in the corresponding graph models. Since the edges take the production order into account, interruption-free manufacture is guaranteed. This corresponds to the determination of Hamilton paths in a directed graph model.

In accordance with a variant, the directed edges are taken into account directly upon the creation of the production sequences for the relevant plant parts or production sequences are subsequently adjusted and/or subdivided on the basis of the directed edges. Thus, either a directed graph model is created directly and the production sequence is derived from it, which directly takes the production order of the products into account on the basis of the directed edges, or an already determined production sequence is adjusted and/or subdivided on the basis of the directed graph model. A subdivision of a production sequence is necessary if not all products included in the production sequence can be manufactured in an interruption-free production order.

In accordance with a variant, the method comprises the step of subdividing the overall production sequence in accordance with the subdivision of the production sequences. If a production sequence is subdivided based on the directed graph model, the overall production sequence based on it is also divided accordingly.

In an alternative variant for the creation of a directed graph model, directed lists, in particular lists of directed vectors, directed adjacency matrices or comparable directed data structures can also be used for recording networks of relationships.

According to a further variant, the method comprises the step of filtering the production list and/or the production sub-lists, in particular with respect to the delivery dates. Thereby, the production lists and/or production sub-lists are preferably filtered prior to the analysis of the production sub-lists. Filtering is carried out in particular on the basis of delivery dates for the products to be manufactured in the production plant. Filtering can be used, for example, to sort out products to be manufactured that are not currently time-critical and can/must only be taken into account at a later point in time when planning production in the production plant. Thus, the result of the filtering is a list of products relevant to the current process situation, which are to be manufactured in the production plant.

### BRIEF DESCRIPTION OF THE DRAWINGS

The invention is explained in more detail below with reference to the exemplary embodiments shown in the figures.

FIG. 1 shows a schematic view of a production plant with a plurality of separate, successive plant parts according to a first exemplary embodiment.

FIGS. 2a-2d shows detailed examples of graph models of production sequences and superimposition of the graph models to determine an overall production sequence.

FIGS. 3a-3d shows reduced examples of graph models of production sequences and overall production sequences derived from them.

### DETAILED DESCRIPTION

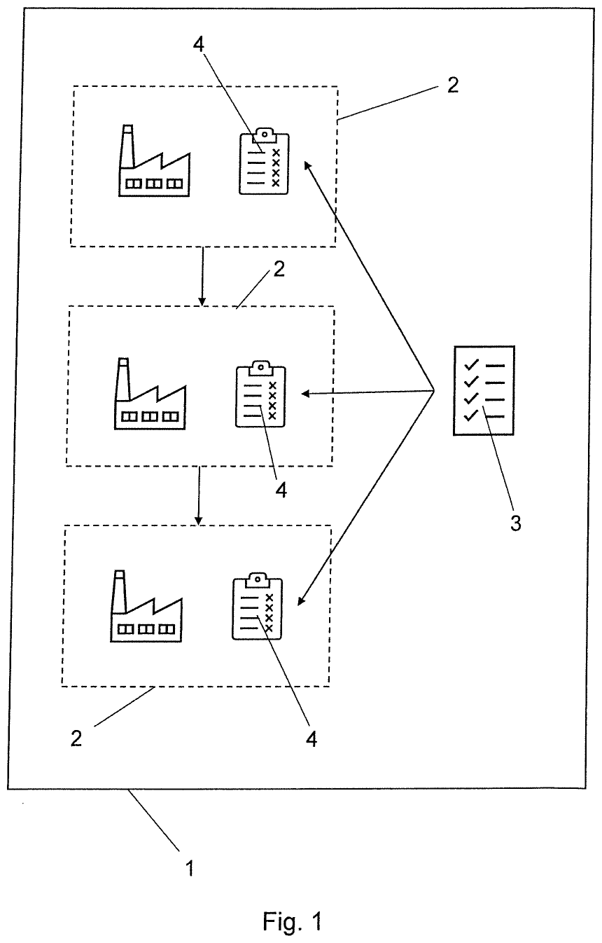

FIG. 1 shows a schematic view of a production plant 1 with a plurality of successive plant parts 2 according to a first exemplary embodiment. Thereby, the production plant 1 is designed to carry out a method for planning production in the production plant 1. The production plant 1 in FIG. 1 is a metallurgical production plant 1 for producing industrial goods such as metal semi-finished products and/or metal end products. In the first exemplary embodiment shown in FIG. 1, the production plant 1 comprises three separate, successive plant parts 2, specifically, in order from top to bottom: a casting-rolling mill, a pickling tandem line and a hot-dip galvanizing process.

The plant parts 2 have been selected purely as examples and are limited to three for the sake of clarity. In principle, the number and type of plant parts 2 is not limited and relates, for example, to blast furnaces, sintering plants, converters, electric arc furnaces, induction furnaces, ladle furnaces, vacuum treatment plants, powder atomization plants, continuous casting machines, ingot or mold foundries, hot rolling mills, cold rolling mills, pickling lines, rewinding lines, blasting lines, galvanizing lines, tinning lines, painting lines, slitting lines, cross-cutting lines, finishing lines, forging presses, closed-die forging, reheating furnaces, heat treatment lines, bell annealing, or the like.

In particular, the method is used for the manufacture of steel, non-ferrous metals, slabs, blocks, bars, strips, sheets, tubes, beams, forgings or the like. The method comprises, for example, one or more of the following process steps: Melting, casting, hot forming, cold forming, pickling, coating, or the like.

The products P1, P2, P3, P4, P5 to be manufactured in the production plant 1 are available in a production list 3 according to the first exemplary embodiment in FIG. 1. From the production list 3, production sub-lists 4 can be established for the separate consecutive plant parts 2. The production list 3 can also include expected future orders, i.e. products P1, P2, P3, P4, P5 that are likely to be manufactured in the future.

To plan production in the production plant 1, which consists of the separate, consecutive plant parts 2, the production sub-lists for plant part 2 are analyzed and production sequences for the relevant plant parts 2 are determined. In each production sequence, the products P1, P2, P3, P4, P5 that can be manufactured in the relevant plant part 2 are combined, which can be manufactured in the plant part 2 without restricting or interrupting production. The products P1, P2, P3, P4, P5 listed in the production sub-lists 4 are analyzed to determine whether they are manufactured without interruption in the plant part 2. All the products P1, P2, P3, P4, P5 of the production sub-list 4 that can be manufactured without interruption are combined in a production sequence. Therefore, the production sub-list 4 is divided into a plurality of production sequences, wherein each production sequence can be carried out by the plant part without interruption. In particular, a product is assigned to a production sequence of a plant part 2 if the product can be manufactured upstream or downstream of a product included in the production sequence without restricting or interrupting production.

In accordance with an advantageous variant, limit values for product properties, which cause a production restriction or a production interruption, are defined for the separate plant parts 2 As a result, the production sub-lists 4 can be grouped into the production sequences quickly and easily.

In accordance with the method for planning production in the production plant 1, the production sequences of the plant parts 2 are analyzed to identify products P1, P2, P3, P4, P5, which are included in a joint production sequence in all plant parts 2. On the basis of such analysis, an overall production sequence is determined which includes the products P1, P2, P3, P4, P5, which are included in a joint production sequence for all plant parts 2. Thus, the overall production sequence ensures that the products P1, P2, P3, P4, P5 included therein can be manufactured on all plant parts 2 without interruption.

Expediently, only products P1, P2, P3, P4, P5 that require production in the same successive plant parts 2 are taken into account in an overall production sequence. At the same time, the production sequences of the plant parts 2 can at least partially include products P1, P2, P3, P4, P5, which are part of different overall production sequences.

The method for planning production in the production plant 1 consisting of a plurality of separate, successive plant parts 2 preferably comprises optimizing a plurality of overall production sequences to determine a master production sequence, which preferably comprises all products P1, P2, P3, P4, P5 to be manufactured in the production plant 1 from the production list 3/the production sub-lists 4. Thus, not only are overall production sequences determined which optimize the manufacture of the products P1, P2, P3, P4, P5 included therein across all plant parts 2 of the production plant 1, but the carrying out of the plurality of overall production plants in the plant parts 2 of the production plant 1 is also optimized.

When determining the master production sequence, for example, the number, weight, volume or similar properties of the products P1, P2, P3, P4, P5 are taken into account, which are manufactured at an early stage in a production sequence, but are only taken into account further at a later point in time in subsequent overall production sequences. Furthermore, storage capacities of the production plant 1, the plant parts 2, intermediate storage facilities or the like can be taken into account in this respect.

The optimization of a plurality of overall production sequences to determine the master production sequence is based, for example, on an algorithm for solving the job shop problem, in particular on an algorithm from the field of mixed-integer optimization, genetic optimization, heuristic methods from operation research such as particle swarm, simulated annealing, tabu search, predator-prey, or comparable algorithms.

The master production sequence can be determined forwards or backwards along the corresponding process chain.

When determining the at least one overall production sequence and/or the master production sequence, prioritization of the plant parts 2 can be taken into account. Prioritization is based, for example, on the added value, capacity utilization or other properties of the plant parts 2.

In accordance with an advantageous variant, the method comprises the step of checking the production sequences for the relevant plant parts 2 for an actual interruption-free carrying out in the relevant plant part 2. Although the products P1, P2, P3, P4, P5 in a production sequence can theoretically be carried out without interruption in the plant part 2, it is quite possible that the production sequence as a whole is too long and cannot be carried out without interruption. For example, maintenance work on the plant part 2 can be due during the production sequence, such that the production sequence must be interrupted for the maintenance work. Therefore, upon the check, the operational conditions and processes of the relevant plant part 2, in particular necessary maintenance downtimes, the replacement of operating change parts or the like, are taken into account.

If an interruption-free carrying out is not possible in the plant part 2, the relevant production sequence is preferably divided. The integration of the production sequence to be divided into an overall production sequence is taken into account upon division, such that dividing the overall production sequence is preferably avoided.

After the overall production sequences and, if applicable, the master production sequence have been determined by means of the method, the corresponding processing of the production sequences by the plant part 2 can be optimized for the plant parts 2. Thus, the order in which the products P1, P2, P3, P4, P5 of the production sequence are manufactured is determined for each plant part 2. For example, sorting is carried out according to one or more product properties. The optimization is based, for example, on an algorithm for solving the traveling salesman problem, in particular on an algorithm from the field of mixed-integer optimization, genetic optimization, heuristic methods from operation research such as particle swarm, simulated annealing, tabu search, predator-prey, or comparable algorithms.

When planning the production in the production plant 1, the method can take into account the starting materials and their states for the products P1, P2, P3, P4, P5 to be manufactured. As a result, the economic efficiency of the production plant 1 can be further optimized, since capital tied up in the starting materials, for example, can be taken into account.

According to a further variant, the method comprises defining a time horizon for the carrying out of the method, in particular the manufacture of the products P1, P2, P3, P4, P5 from the production list 3 and/or the production sub-lists 4. If production capacities are still available within the defined time horizon, current production can be adjusted at a later point in time, for example.

In a particularly advantageous variant of the method, a new product to be manufactured can be inserted into existing production sequences and/or an overall production sequence. In particular, due dates of the products to be inserted P1, P2, P3, P4, P5, product properties or the like are taken into account. A new product to be manufactured is preferably only included in an existing overall production sequence if this does not unnecessarily delay the overall production sequence, in particular if it causes a separation of the overall production sequence. A new product to be manufactured is inserted in particular if two existing overall production sequences can be linked as a result.

Expediently, the method is carried out iteratively, in particular on a fixed chronological basis or after certain events such as completion of an optimization run, changes in state, receipt of new orders, or the like.

In accordance with an advantageous variant, upon the determination of production sequences, it is taken into account if two products P1, P2, P3, P4, P5 can only be manufactured in a predetermined order without restricting or interrupting production.

In a preferred variant, analyzing the production sub-lists 4 to determine production sequences for the relevant plant parts 2 comprises creating graph models for the plant parts 2. In the graph models, the products P1, P2, P3, P4, P5 included in the production sub-lists 4 are represented by a node in the graph model. The nodes are connected to one another via an edge if the relevant products P1, P2, P3, P4, P5 can be manufactured in the plant part 2 without restricting or interrupting production.

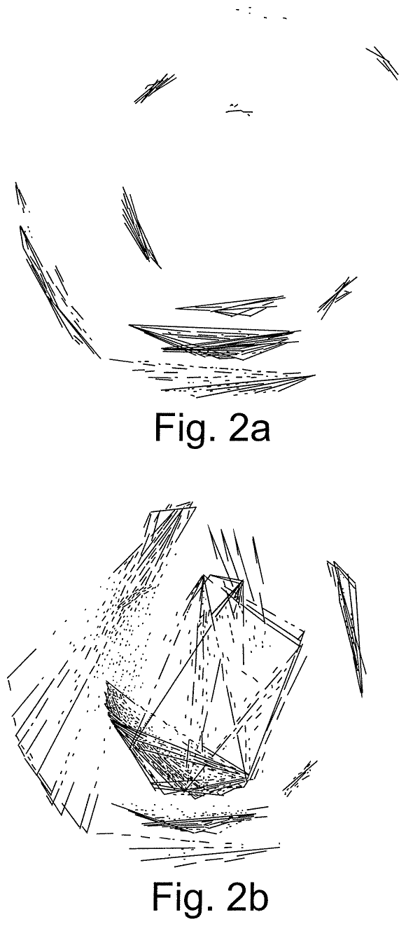

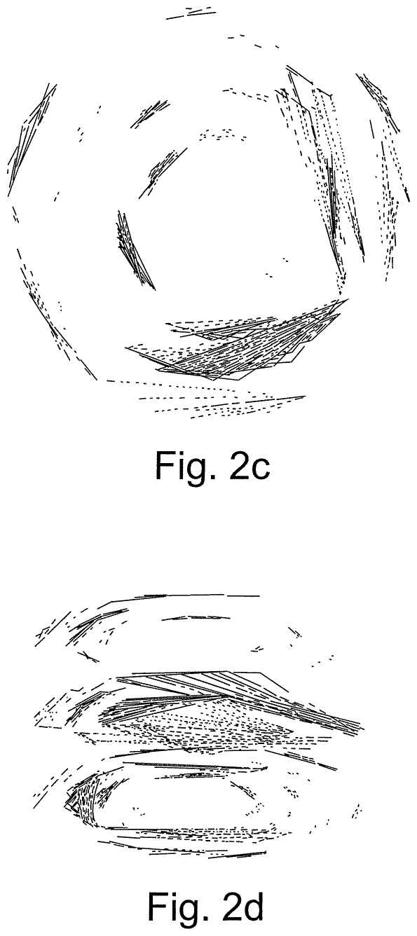

FIGS. 2a to 2c show detailed examples of graph models of production sequences for the three plant parts 2 of the production plant 1 from FIG. 1, and FIG. 2d shows a superimposition of the graph models from FIGS. 2a to 2c to determine an overall production sequence. In FIGS. 2a to 2d, the angular position of a node represents the carbon of the associated product and the radius represents the strip width of the associated product.

FIG. 2a shows the graph model for the casting-rolling mill, which is the first plant part 2 of the production plant from FIG. 1. The parameters relevant for the analysis of the production sub-lists 4 and the determination of production sequences for such plant part 2 are the steel grade, the carbon content, changes in width and changes in thickness. As can be seen from FIG. 2a, the products P1, P2, P3, P4, P5 with similar carbon content (angular position) and dimensions (radius position) are combined in production sequences for the casting-rolling mill, since these can be manufactured in the casting-rolling mill without interruption.

FIG. 2b shows the graph model for the pickling tandem line, which is the second plant part 2 of the production plant 1 in FIG. 1. The parameters relevant for the analysis of the production sub-lists 4 and the determination of production sequences for this plant part 2 are different pickling speeds, changes in width, changes in thickness at the infeed, changes in thickness at the outfeed and cross-section changes. As can be seen in FIG. 2b, the products P1, P2, P3, P4, P5 with similar dimensions (radius position) are combined in production sequences for the pickling tandem line, since these can be manufactured in the casting-rolling mill without interruption. The carbon content (angular position) is less relevant with respect to the pickling tandem mill than for the casting-rolling mill.

FIG. 2c shows the graph model for the hot-dip galvanizing plant, which is the third and final plant part 2 of the production plant in FIG. 1. The parameters relevant for the analysis of the production sub-lists 4 and the determination of production sequences for this plant part 2 are the annealing treatment, the carbon content, changes in thickness, changes in width and cross-section changes. As can be seen from FIG. 2c, the products P1, P2, P3, P4, P5 with comparable carbon content (angular position) and similar dimensions (radius position) are combined in production sequences for the hot-dip galvanizing plant, since these can be manufactured in the hot-dip galvanizing plant without interruption.

With respect to FIGS. 2a to 2c, it should also be noted that the products P1, P2, P3, P4, P5 to be manufactured in the individual plant parts 2 decreases, since not every cast product is pickled or even hot-dip galvanized. It is also possible for intermediate products to be sold after just one processing step.

FIG. 2d shows a superimposition of the graph models from FIGS. 2a to 2c, wherein the graph model of the casting-rolling mill is depicted at the bottom, the graph model of the pickling tandem line is depicted in the middle and the graph model of the hot-dip galvanizing process is depicted at the top. Overall production sequences can be derived from the superimposition, wherein an overall production sequence only includes products P1, P2, P3, P4, P5, which are included in a joint production sequence in all three plant parts 2.

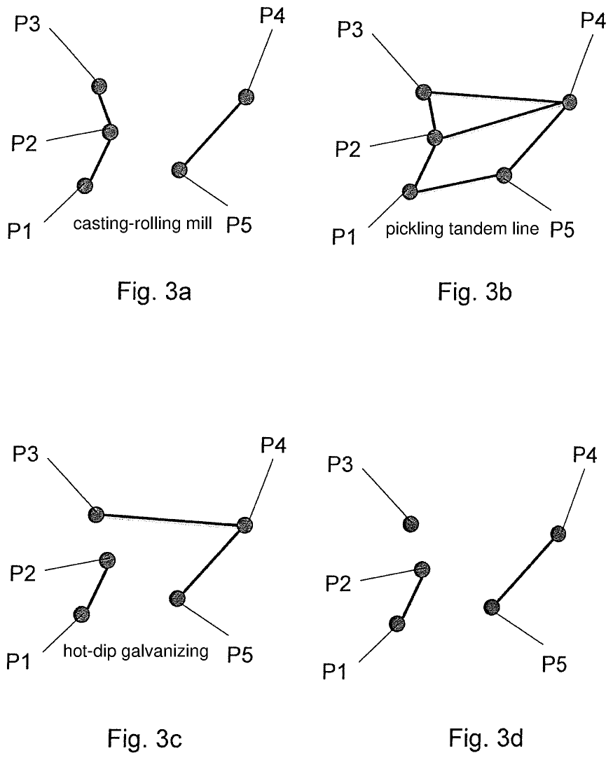

FIGS. 3a to 3d show reduced examples of graph models of production sequences for the three plant parts 2 from FIG. 1 and FIG. 2 and an overall production sequence derived from them.

FIG. 3a shows that the casting-rolling mill includes the products P1, P2 and P3 in a first production sequence and the products P4 and P5 in a second production sequence.

FIG. 3b shows that the products P1 to P5 can be manufactured in one production sequence in the pickling tandem line.

FIG. 3c shows that the hot-dip galvanizing plant includes the products P1 and P2 in a first production sequence and the products P3, P4 and P5 in a second production sequence.

This results in the three overall production sequences shown in FIG. 3d. The first overall production sequence comprises the products P1 and P2, the second overall production sequence comprises the product P3 and the third overall production sequence comprises the products P4 and P5.

A master production sequence for the production plant 1 with the three plant parts 2 can be determined from these three overall production sequences.

First, for example, the overall production sequence for the products P1 and P2 is carried out; this can also be carried out in all plant parts 2 without interruption.

Since the product P3 is included in a production sequence with the products P1 and P2 with respect to the casting-rolling mill, i.e. it can be manufactured without interruption, the product P3 is also manufactured directly, and stored if necessary, in the casting-rolling mill. With respect to the pickling tandem line, the product P3 can be manufactured with the products P4 and P5 in one production sequence, i.e. without interruption. Therefore, the product P3 is stored until products P4 and p5 have been manufactured in the casting-rolling mill. Subsequently, the products P3 to P5 can be manufactured in the pickling tandem line. Since the products P3 to P5 are also included in a production sequence in the hot-dip galvanizing process, i.e. they can be manufactured without interruption, the master production sequence determined in this manner substantially only includes the interruption with respect to the change between the two production sequences in the casting-rolling mill. The interruption in the hot-dip galvanizing process is at least partially or even completely compensated for by the intermediate storage of the product P3 after the first production sequence in the casting-rolling mill.

As an alternative to the graph models, analyzing the production sub-lists 4 to determine production sequences for the relevant plant parts 2 can comprise creating lists, in particular lists of vectors, adjacency matrices, or comparable data structures for recording relationship networks.

In accordance with a variant, upon the determination of production sequences, it is taken into account that two products P1, P2, P3, P4, P5 can only be manufactured in a predetermined order without restricting or interrupting production. In this respect, for example, the nodes in a graph model are connected to one another via a directed edge if the relevant products P1, P2, P3, P4, P5 can be manufactured in the relevant production order in the plant part without restricting or interrupting production. In such a case, the determination of overall production sequences corresponds to finding so-called “Hamilton paths.”

### LIST OF REFERENCE SIGNS

1 Production plant
2 Plant part
3 Production list
4 Production sub-list
P1 Product
P2 Product
P3 Product
P4 Product
P5 Product

1.-20. (canceled)

21. A method for planning production in a production plant (1) comprising a plurality of separate, successive plant parts (2), wherein products (P1, P2, P3, P4, P5) to be manufactured in the production plant (1) are available in a production list (3) and production sub-lists (4) are available for the separate, successive plant parts (2) or are established from the production list (3), comprising:
analyzing the production sub-lists (4) and determining production sequences for relevant plant parts (2),
wherein those of the products (P1, P2, P3, P4, P5) that can be manufactured in the relevant plant parts (2) without restricting or interrupting production are combined in each of the production sequences, and
analyzing the production sequences of the plant parts (2) and determining at least one overall production sequence for the production plant (1),
wherein an overall production sequence includes those products (P1, P2, P3, P4, P5) that include all plant parts (2) in a joint production sequence.

22. The method according to claim 21, further comprising
defining limit values for product properties in the separate plant parts (2) that cause a production restriction or a production interruption.

23. The method according to claim 21,
wherein analyzing the production sub-lists (4) to determine the production sequences for the relevant plant parts (2) comprises creating graph models for the plant parts (2),
wherein, in a graph model, the products (P1, P2, P3, P4, P5) included in the production sub-lists (4) represent a node in the graph model and the nodes are connected to one another via an edge if the relevant products (P1, P2, P3, P4, P5) can be manufactured in the plant part (2) without restricting or interrupting production.

24. The method according to claim 23,
wherein analyzing the production sequences of the plant parts (2) to determine the at least one overall production sequence for the production plant comprises evaluating the graph models for the plant parts,
wherein products (P1, P2, P3, P4, P5) are included in an overall production sequence if such products (P1, P2, P3, P4, P5) are connected via an edge for all plant parts in the corresponding graph models.

25. The method according to claim 21,
wherein analyzing the production sub-lists (4) to determine the production sequences for the relevant plant parts (2) comprises creating lists of vectors or adjacency matrices for recording relationship networks.

26. The method according to claim 21,
further comprising optimizing a plurality of overall production sequences to determine a master production sequence, which comprises all products (P1, P2, P3, P4, P5) from the production list (3) and/or the production sub-lists (4) to be manufactured in the production plant (1).

27. The method according to claim 26,
wherein a number, weight, or volume of products (P1, P2, P3, P4, P5) that are manufactured at an early stage in a production sequence, but are only taken into account at a later point in time in subsequent overall production sequences, are taken into account when determining the master production sequence, and/or storage capacities of the production plant (1), the plant parts (2), or intermediate storage facilities.

28. The method according to claim 26,
further comprising determining production start times and production end times for the products to be manufactured (P1, P2, P3, P4, P5) listed in the production list (3) or in the production sub-lists (4).

29. The method according to claim 26,
wherein a prioritization of the plant parts (2) is taken into account when determining the at least one overall production sequence and/or the master production sequence, and
wherein the prioritization is based on an added value or capacity utilization of the plant parts (2).

30. The method according to claim 21,
further comprising checking the production sequences for the relevant plant parts (2) for an actual interruption-free carrying out in the relevant plant part (2),
wherein, upon the checking, operational conditions and processes of the relevant plant part (2) selected from the group consisting of necessary maintenance downtimes and replacement of operating change parts are taken into account.

31. The method according to claim 30,
further comprising dividing of production sequences if an actual interruption-free carrying out in the relevant plant part (2) is not possible,
wherein in an integration of the production sequence to be divided into an overall production sequence is taken into account upon division, such that division of the overall production sequence is avoided.

32. The method according to claim 21,
further comprising optimizing the production sequences for the plant parts (2) with regard to processing by the relevant plant part (2).

33. The method according to claim 21,
wherein the method takes into account starting materials and their states for the products to be manufactured (P1, P2, P3, P4, P5).

34. The method according to claim 21,
further comprising inserting a new product to be manufactured into existing production sequences and/or an overall production sequence,
wherein a due date or product properties of the new product to be manufactured are taken into account upon insertion.

35. The method according to claim 21,
further comprising taking into account, in the determination of the production sequences, whether two products (P1, P2, P3, P4, P5) can only be manufactured in a predetermined order without restricting or interrupting production.

36. The method according to claim 35,
wherein analyzing the production sub-lists to determine the production sequences for the relevant plant parts comprises creating graph models for the plant part,
wherein, in a graph model, the products included in the production sub-lists represent a node in the graph model and the nodes are connected to one another via a directed edge, if the corresponding products (P1, P2, P3, P4, P5) can be manufactured in the corresponding production order without restricting or interrupting production in the plant part.

37. The method according to claim 36,
wherein analyzing the production sequences of the plant parts to determine at least one overall production sequence for the production plant comprises evaluating the graph models for the plant parts,
wherein products (P1, P2, P3, P4, P5) are included in an overall production sequence if such products (P1, P2, P3, P4, P5) are connected via directed edges for all plant parts in the corresponding graph models.

38. The method according to claim 21,
further comprising filtering the production list (3) and/or the production sub-lists (4) with respect to delivery dates.

39. A system for planning production in a metallurgical production plant for producing metal semi-finished products and/or metal end products, the production plant comprising a plurality of separate, successive plant parts,
wherein the products (P1, P2, P3, P4, P5) to be manufactured in the production plant (1) are available in a production list (3) and production sub-lists (4) are available for the separate, successive plant parts (2) or are established from the production list (3), comprising:
a central data processing device with communication interfaces to the plant parts (2), wherein the system is configured to carry out the method according to claim 21.

40. A computer program, contained in a non-transitory memory, comprising instructions that, when the computer program is executed by a computer, cause the computer to execute the method according to claim 21.
